(19) United States
(12) Patent Application Publication
(10) Pub. No.: US 2017/0134743 A1
(43) Pub. Date: May 11, 2017

(54) APPARATUS FOR DECODING IMAGE AND METHOD THEREFORE

(71) Applicant: INTELLECTUAL DISCOVERY CO., LTD., Seoul (KR)

(72) Inventors: Dong Gyu SIM, Seoul (KR); Yong Jo AHN, Seoul (KR); Woong LIM, Yangju-si (KR)

(73) Assignee: INTELLECTUAL DISCOVERY CO., LTD., Seoul (KR)

(21) Appl. No.: 15/127,503

(22) PCT Filed: Jan. 19, 2015
(86) PCT No.: PCT/KR2015/000444

§ 371 Date: Sep. 20, 2016

(30) Foreign Application Priority Data
Mar. 31, 2014 (KR) 10-2014-0037578
Mar. 31, 2014 (KR) 10-2014-0037579

(51) Int. Cl. H04N 19/503; H04N 19/44; H04N 19/176; H04N 19/124

(52) U.S. Cl. CPC H04N 19/503; H04N 19/124; H04N 19/44; H04N 19/176

(57) ABSTRACT

An apparatus and a method for decoding an image are disclosed. More specifically, the apparatus for decoding an image, according to one embodiment of the present invention, comprises an adaptive inverse-quantization unit for performing inverse-quantization on a block to be decoded, by using scaling list information set with respect to one region including the block to be decoded within an image among the scaling list information which is separately set in each partitioned region of the image.

### TECHNICAL FIELD

The present invention relates to a video decoding apparatus and method.

### BACKGROUND ART

The Moving Picture Experts Group (MPEG) and Video Coding Expert Group (VCEG) organized the Joint Collaborative Team on Video Coding (JCT-VC) and started to develop next-generation video standard technology, known as High Efficiency Video Coding (HEVC), in 2010. HEVC standard technology was completed in January 2013 and HEVC enables compression efficiency to be improved by about 50% compared to H.264/AVC High Profile, which was previously known to exhibit the highest compression performance among existing video compression standards.

In a subsequent standardization procedure, the standardization of extensions for scalable video and multi-view video is continually progressing, and in addition, RExt (Range Extension) standards for compression of various types of video content, such as screen content video, are also under development. Among these standards, in RExt, technology such as intra-block copy is included so as to effectively compress computer-generated content, or content in which the computer-generated content is mixed with natural images. This technology is implemented such that a signal similar to the current block in an existing intra-predicted picture is searched for in a decoded neighboring area in the same picture, and is represented by syntax elements identical to those predicted on a time axis. Existing intra prediction is zero-order prediction, which generates a predicted signal in the block using neighboring reconstructed pixel values and then obtains a residual signal. However, since intra-block copy technology searches the neighboring reconstructed region for the signal most similar to the current block, the complexity thereof has increased, but compression performance may be improved via high prediction performance.

In relation to this, Korean Patent Application Publication No. 1997-0046435 (entitled “Contour Extraction Method and Encoding method for the Same”) discloses technology for filtering a plurality of segmented images to simplify boundaries of segmented images, and extracting smoothened complete contours in eight directions from a grid structure having a predetermined size.

Meanwhile, demand for next-generation video compression standards, together with demand for high-quality video service, such as recent Full High Definition (FHD) and Ultra High Definition (UHD) service, has increased. In the above-described HEVC Range extension standards, discussions are currently being held for the support of various color formats and bit depths.

In HEVC, technology in which various types of encoding/decoding required by next-generation video standards, as well as encoding efficiency, are taken into consideration has been adopted at the standardization stage. For example, there are technologies such as Merge Estimation Region (MER), for guaranteeing parallelism for decoding of a new picture partition unit, known as a ‘tile’, in which the parallelism of encoding/decoding procedures is taken into consideration, and a Prediction Unit (PU). In particular, in compliance with the request of markets for high-resolution and high-video quality, technology such as a deblocking filter, a Sample Adaptive Offset (SAO), and a scaling list has been adopted to improve subjective video quality.

In relation to this, Korean Patent Application Publication No. 2013-0077047 (entitled “Method and Apparatus for Image Encoding/Decoding”) discloses technology which includes the steps of deriving a scale factor for the current block depending on whether the current block is a transform skip block, and scaling the current block based on the scale factor, wherein the scale factor for the current block is derived based on the positions of transform coefficients in the current block, and the transform skip block is a block in which a transform is not applied to the current block and is specified based on information indicating whether to apply an inverse transform to the current block.

### DISCLOSURE

### Technical Problem

An object of some embodiments of the present invention is to provide an apparatus and method, which adaptively apply scaling list information to improve the subjective quality of compressed video, thus improving subjective quality and encoding/decoding efficiency.

Another object of some embodiments of the present invention is to provide a video decoding apparatus and method, which can generate predicted signals using different prediction modes for respective partitioned regions by combining technologies based on an intra-prediction mode and an intra-block copy mode with each other so as to improve existing intra-block copy technology.

However, the technical objects to be accomplished by the present embodiments are not limited to the above-described technical objects, and other technical objects may be present.

### Technical Solution

In order to accomplish the above objects, a video decoding apparatus according to an embodiment of the present invention includes an adaptive inverse quantization unit for performing inverse quantization on a block to be decoded using scaling list information, which is set for a certain region including the block to be decoded in an image, among pieces of scaling list information separately set for respective partitioned regions of the image.

A video decoding apparatus according to another embodiment of the present invention includes a region partitioning unit for, when a current block to be decoded is encoded in a partial block copy mode, among intra-prediction modes, partitioning a corresponding region, which corresponds to the current block, in a previously decoded area into an arbitrary shape; and a predicted signal generation unit for generating respective predicted signals for the current block based on an intra-prediction mode or an intra-block copy mode for respective corresponding regions partitioned by the region partitioning unit.

A video decoding method according to an embodiment of the present invention includes extracting pieces of scaling list information, which are separately set for respective partitioned regions of an image, from a bitstream; and performing inverse quantization on a block to be decoded, using scaling list information set for a certain region including a block to be decoded in the image, among the pieces of scaling list information.

A video decoding method according to another embodiment of the present invention includes determining whether a current block to be decoded has been encoded in a partial block copy mode, among intra-prediction modes; when the current block has been encoded in the partial block copy mode, partitioning a corresponding region, which corresponds to the current block, in a previously decoded area into an arbitrary shape; and generating predicted signals for the current block, based on an intra-prediction mode or an intra-block copy mode for respective corresponding regions partitioned at the partitioning.

### Advantageous Effects

In some embodiments of the present invention, the transmission unit of scaling list information is selectively applied, and thus a region in which adaptive quantization is to be performed may be more flexibly selected depending on visual perception characteristics.

Further, in some embodiments of the present invention, prediction and merging are performed based on scaling list information set in a region that is temporally coincident with the current block, or scaling list information set in a neighboring region that is spatially adjacent to the current block, thus reducing the amount of scaling list information that is transmitted.

Furthermore, some embodiments of the present invention may contribute to the improvement of subjective quality of compressed/reconstructed video.

Furthermore, in some embodiments of the present invention, video may be effectively compressed/reconstructed by means of geometric forms such as image contours and the distribution of pixel values, which can be criteria for region partitioning when video is encoded/decoded.

Furthermore, in some embodiments of the present invention, predicted signals based on an intra-prediction mode or an intra-block copy mode are adaptively generated for respective partitioned regions, thus improving the overall intra-prediction performance.

### DESCRIPTION OF DRAWINGS

FIG. 1 is a block diagram showing the overall configuration of a video encoding apparatus according to an embodiment of the present invention;

FIG. 2 is a diagram showing in detail the operation of the adaptive quantization unit selector shown in FIG. 1;

FIG. 3 is a diagram showing in detail the operation of the adaptive quantization unit shown in FIG. 1;

FIG. 4 is a block diagram showing the overall configuration of a video decoding apparatus according to an embodiment of the present invention;

FIG. 5 is a diagram showing various examples of partitioned regions of an image;

FIG. 6 is a diagram showing various examples of pieces of scaling list information, set separately for respective partitioned regions;

FIG. 7 is a diagram showing an example of the scan order and scaling values of blocks to be decoded in scaling list information;

FIG. 8 is a diagram showing another example of the scan order and scaling values of blocks to be decoded in the scaling list information;

FIG. 9 is a diagram showing an example of residual scaling list information and predictive scaling list information;

FIG. 10 is a diagram showing an example of merging between pieces of scaling list information;

FIG. 11 is a flowchart showing a video decoding method according to an embodiment of the present invention;

FIG. 12 is a block diagram showing the overall configuration of a video encoding apparatus according to another embodiment of the present invention;

FIG. 13 is a block diagram showing the overall configuration of a video decoding apparatus according to another embodiment of the present invention;

FIG. 14 is a diagram showing in detail the operations of some of the components shown in FIG. 13;

FIG. 15 is a diagram showing an example of the current block to be decoded and a corresponding region in a previously decoded area;

FIG. 16 is a diagram showing examples of a partitioned corresponding region, and regions decoded in an intra-prediction mode and an intra-block copy mode;

FIG. 17 is a diagram showing examples of a partitioned corresponding region and a region decoded in an intra-prediction mode;

FIG. 18 is a diagram showing examples of region flag information, a plurality of target blocks that are spatially adjacent to each other and constitute an arbitrary row, and lower blocks contained in each target block;

FIG. 19 is a diagram showing an example of a procedure in which the current block, composed of unit blocks having a minimum size, is decoded;

FIG. 20 is a flowchart showing a video decoding method according to another embodiment of the present invention;

FIG. 21 is a block diagram showing a video encoding apparatus according to a further embodiment of the present invention; and

FIG. 22 is a block diagram showing a video decoding apparatus according to a further embodiment of the present invention.

### BEST MODE

Embodiments of the present invention are described with reference to the accompanying drawings in order to describe the present invention in detail so that those having ordinary knowledge in the technical field to which the present invention pertains can easily practice the present invention. However, the present invention may be implemented in various forms, and is not limited by the following embodiments. In the drawings, the illustration of components that are not directly related to the present invention will be omitted, for clear description of the present invention, and the same reference numerals are used to designate the same or similar elements throughout the drawings.

Further, throughout the entire specification, it should be understood that a representation indicating that a first component is “connected” to a second component may include the case where the first component is electrically connected to the second component with some other component interposed therebetween, as well as the case where the first component is “directly connected” to the second component. Furthermore, it should be understood that a representation indicating that a first component “includes” a second component means that other components may be further included, without excluding the possibility that other components will be added, unless a description to the contrary is specifically pointed out in context.

Throughout the present specification, a representation indicating that a first component “includes” a second component means that other components may be further included, without excluding the possibility that other components will be added, unless a description to the contrary is specifically pointed out in context. The term “step of performing ˜” or “step of ˜” used throughout the present specification does not mean the “step for ˜”.

Terms such as “first” and “second” may be used to describe various elements, but the elements are not restricted by the terms. The terms are used only to distinguish one element from the other element.

Furthermore, element units described in the embodiments of the present invention are independently shown in order to indicate different and characteristic functions, but this does not mean that each of the element units is formed of a separate piece of hardware or software. That is, the element units are arranged and included for convenience of description, and at least two of the element units may form one element unit or one element unit may be divided into a plurality of element units to perform their own functions. An embodiment in which the element units are integrated and an embodiment in which the element units are separated are included in the scope of the present invention, unless it departs from the essence of the present invention.

Hereinafter, a video encoding/decoding apparatus proposed by the present invention will be described in detail with reference to the attached drawings.

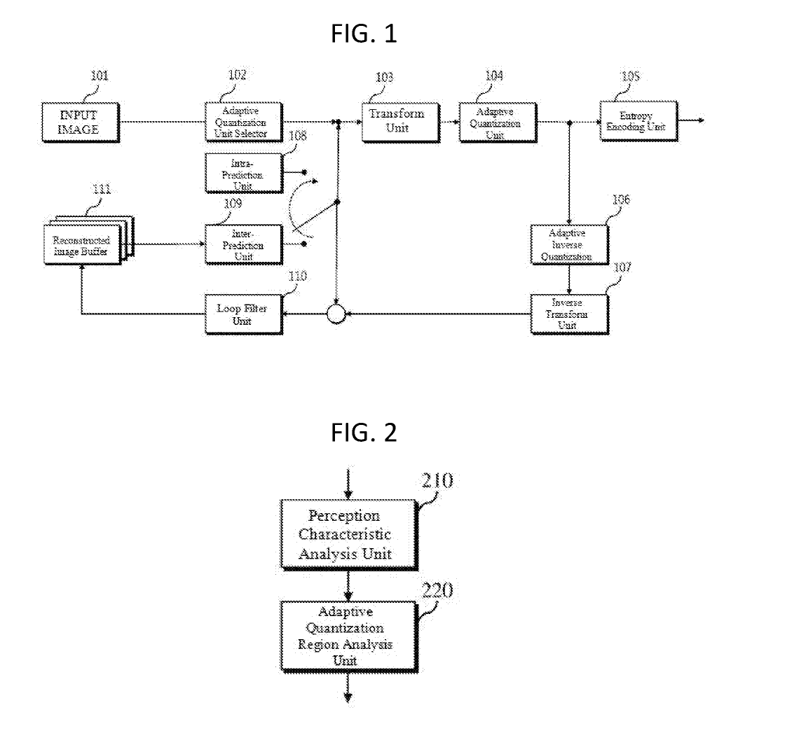

FIG. 1 is a block diagram showing a video encoding apparatus according to an embodiment of the present invention.

A video encoding apparatus according to an embodiment of the present invention may include an adaptive quantization unit selector 102, a transform unit 103, an adaptive quantization unit 104, an entropy encoding unit 105, an adaptive inverse quantization unit 106, an inverse transform unit 107, an intra-prediction unit 108, an inter-prediction unit 109, a loop filter unit 110, and a reconstructed image buffer 111.

The adaptive quantization unit selector 102 may analyze the visual perception characteristics of the input image 101, classify regions on which adaptive quantization is to be performed, and select the structure of an image partition for which scaling list information is to be transmitted.

The adaptive quantization unit 104 may analyze the visual perception characteristics of a residual signal transformed by the transform unit 103 based on the results of prediction, and may perform reference prediction on the scaling list information based on temporally coincident (co-located) or spatially neighboring image partitions.

Further, the adaptive quantization unit 104 may adaptively quantize the transformed signal using predicted scaling list information, and may determine whether to merge the corresponding information with temporally or spatially neighboring image partitions.

Based on the image partition structure selected by the adaptive quantization unit selector 102, the intra-prediction unit 108 and the inter-prediction unit 109 may perform intra prediction based prediction and inter prediction based prediction, respectively.

The inter-prediction unit 109 may execute an inter-prediction mode using information stored in the reconstructed image buffer 111 through the loop filter unit 110. The quantized transform signal output from the adaptive quantization unit 104 is adaptively inversely quantized and inversely transformed by the adaptive inverse quantization unit 106 and the inverse transform unit 107, and is then transferred, together with a predicted signal output from the intra-prediction unit 108 or the inter-prediction unit 109, to the loop filter unit 110.

The quantized transform signal and pieces of encoding information are output through the entropy encoding unit 105 in the form of a bitstream.

FIG. 2 is a diagram showing in detail the operation of the adaptive quantization unit selector shown in FIG. 1.

The above-described adaptive quantization unit selector may include a perception characteristic analysis unit 210 and an adaptive quantization region analysis unit 220.

The perception characteristic analysis unit 210 may analyze the visual perception characteristics of an input image.

More specifically, the perception characteristic analysis unit 210 may take into consideration the visual perception characteristics, such as a luminance adaptation effect, a contrast sensitivity function effect, and a contrast masking effect.

The adaptive quantization region analysis unit 220 may analyze and classify regions having similar characteristics in an image or regions to be adaptively quantized using the analyzed visual perception characteristics.

In this way, the adaptive quantization unit selector may determine an image partition structure depending on the operations of respective detailed components, and may set whether to use scaling list information for the image partition structure.

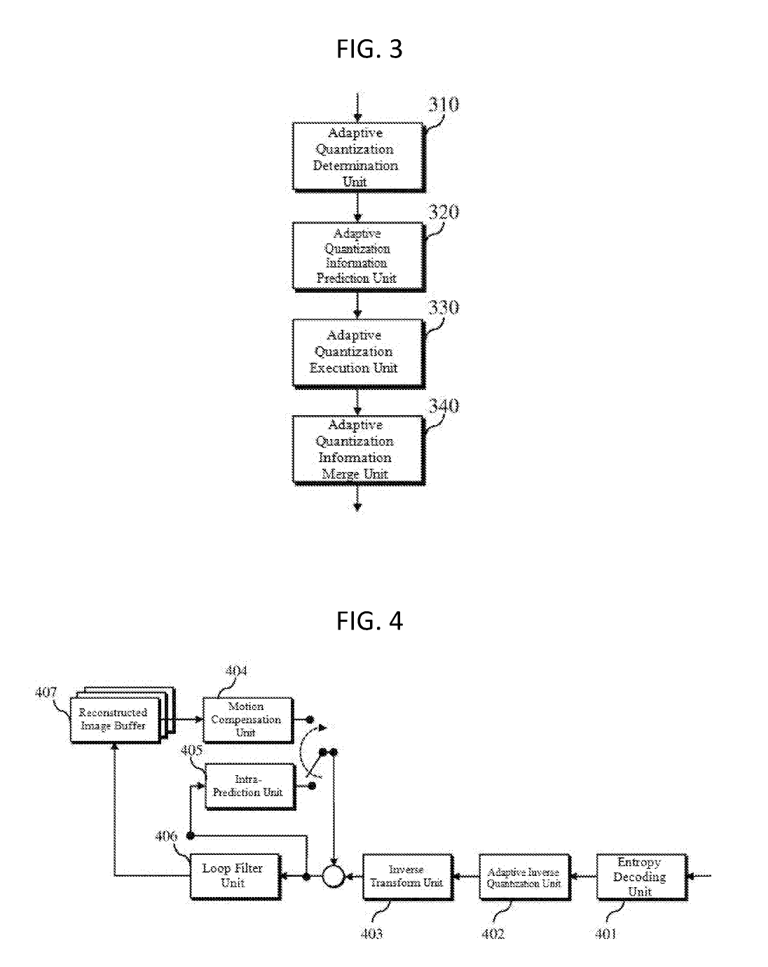

FIG. 3 is a diagram showing in detail the operation of the adaptive quantization unit shown in FIG. 1.

The above-described adaptive quantization unit may include an adaptive quantization determination unit 310, an adaptive quantization information prediction unit 320, an adaptive quantization execution unit 330, and an adaptive quantization information merge unit 340.

The adaptive quantization determination unit 310 may determine whether to adaptively quantize a block to the corresponding block in consideration of the visual perception characteristics of a block to be currently encoded.

The adaptive quantization unit 104 may adaptively quantize a transformed signal using the predictive scaling list information, and may determine whether to merge the corresponding information with a temporally or spatially neighboring image partition.

The adaptive quantization information prediction unit 320 may predict scaling list information, required to adaptively quantize a block, which is determined to be adaptively quantized, from a temporally or spatially neighboring image partition.

The adaptive quantization execution unit 330 may use scaling values which is different or partially different for respective frequency components of the transformed signal for a quantization procedure.

The adaptive quantization information merge unit 340 may determine whether to merge the corresponding scaling list information with the scaling list information of the temporally or spatially neighboring image partition.

For reference, the video encoding procedure and the video decoding procedure correspond to each other in many parts, and thus those skilled in the art will easily understand the video decoding procedure with reference to the description of the video encoding procedure, and vice versa.

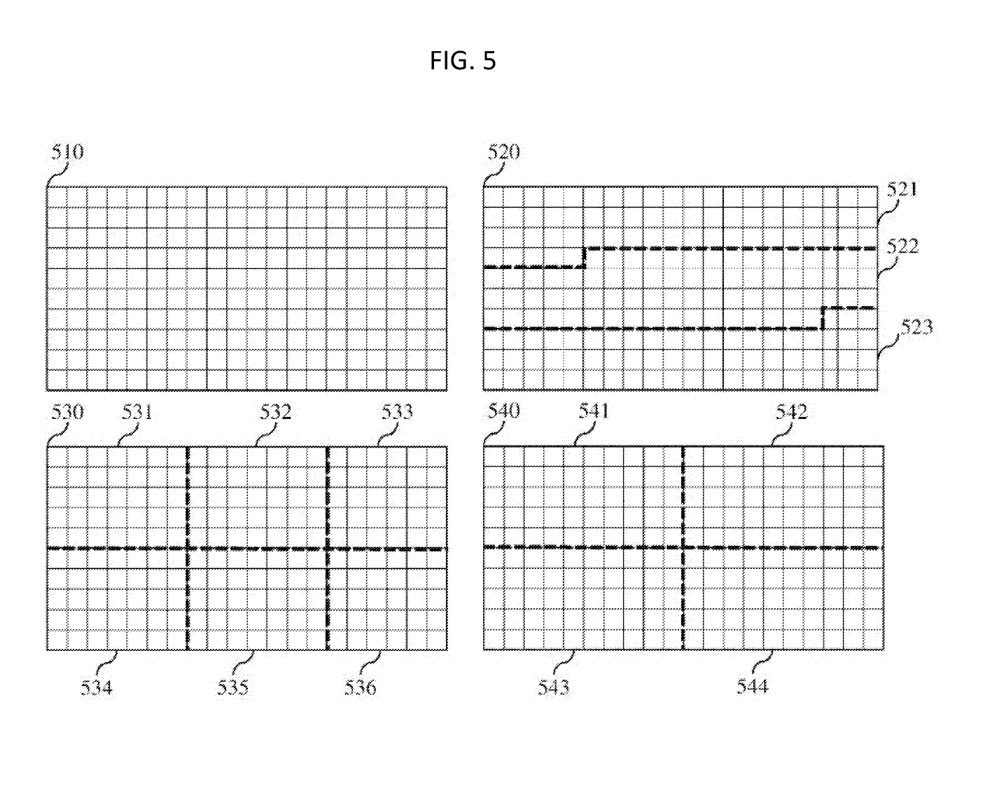

Hereinafter, a video decoding apparatus and detailed operations of individual components thereof will be described in detail with reference to FIGS. 4 to 10.

FIG. 4 is a block diagram showing the overall configuration of a video decoding apparatus according to an embodiment of the present invention.

The video decoding apparatus according to the embodiment of the present invention may include an entropy decoding unit 401, an adaptive inverse quantization unit 402, an inverse transform unit 403, a motion compensation unit 404, an intra-prediction unit 405, a loop filter unit 406, and a reconstructed image buffer 407.

The entropy decoding unit 401 may receive a transmitted bitstream and perform entropy decoding on the bitstream.

The adaptive inverse quantization unit 402 may adaptively perform inverse quantization using both quantization coefficients and the scaling list information corresponding to corresponding image partition, among pieces of information decoded by the entropy decoding unit 401.

Further, when the current block to be decoded is encoded in an inter-prediction mode, the motion compensation unit 404 may generate a predicted signal based on the inter-prediction mode, whereas when the current block to be decoded is encoded in an intra-prediction mode, the intra-prediction unit 405 may generate a predicted signal based on an intra-prediction mode. Here, it is possible to identify the prediction mode in which the current block was encoded, depending on the prediction mode information, among pieces of decoded information, and the motion compensation unit 404 may refer to the information stored in the reconstructed image buffer 407.

The loop filter unit 406 may perform filtering on an input reconstructed signal and transfer the filtered signal to the reconstructed image buffer 407, and the reconstructed signal may be acquired by adding the predicted signal, generated by the motion compensation unit 404 or the intra-prediction unit 405, to a residual signal output from the inverse transform unit 403.

Meanwhile, the video decoding apparatus according to the embodiment of the present invention may include the above-described adaptive inverse quantization unit and entropy decoding unit.

The adaptive inverse quantization unit may perform inverse quantization on a block to be decoded using scaling list information, which is set for a certain region including the block to be decoded in the corresponding image, among pieces of scaling list information which are separately set for respective partitioned regions of the image.

FIG. 5 is a diagram showing various examples of partitioned regions of an image.

Respective pieces of scaling list information according to the present invention may be separately set for respective partitioned regions of an image, and the partitioning of the image may be performed in various forms, as shown in FIG. 5. The regions may be generated by partitioning the image into units respectively corresponding to any one of a picture 510, a slice 520, a tile 530, and a quad-tree 540.

Referring to a first drawing, the image may be partitioned into picture units, and the picture 510 itself may be a partitioned region in the present invention.

Referring to a second drawing, the image is partitioned into slice units, wherein individual slices 521, 522, and 523 may be partitioned regions in the present invention.

Referring to a third drawing, the image is partitioned into tile units, wherein individual tiles 531, 532, and 533 may be partitioned regions in the present invention.

Referring to a fourth drawing, the image is partitioned into quad-tree units, wherein individual units 541, 542, and 543 may be partitioned regions in the present invention.

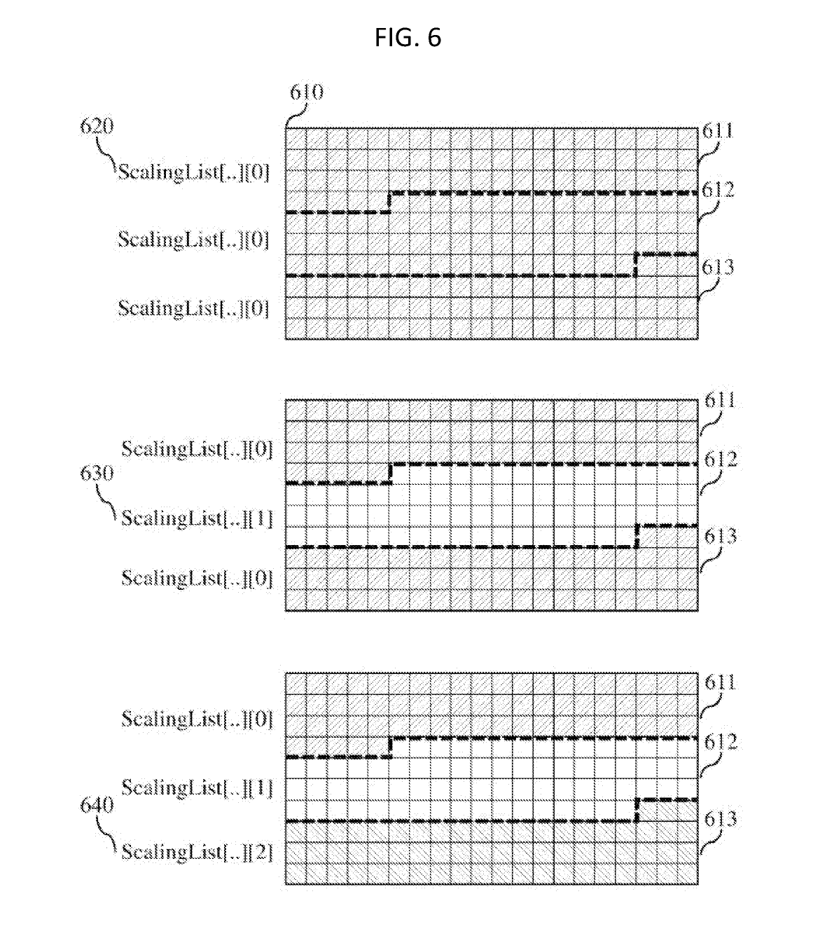

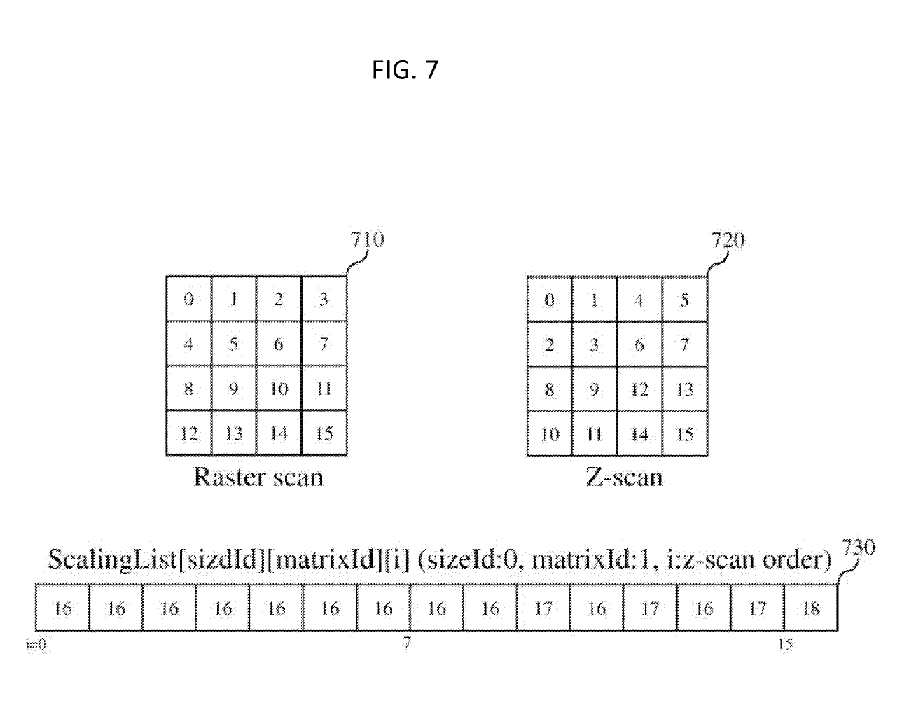

FIG. 6 is a diagram showing various examples of pieces of scaling list information separately set for respective partitioned regions.

A given image 610 is partitioned into slices, wherein partitioned regions are indicated by slice 0 611, slice 1 612, and slice 2 613, respectively.

Referring to a first drawing, partitioned regions are set to identical scaling list information, that is,

ScalingList[0] 620. In this case, pieces of scaling list information are identical to each other.

Referring to a second drawing, among partitioned regions, slice 0 611 and slice 2 613 are set to the identical scaling list information scalingList[0] 620, and slice 1 612 is set to another piece of scaling list information ScalingList[1] 630. In this case, some pieces of scaling list information are identical, and others are different.

Referring to a third drawing, among partitioned regions, scaling list information for slice 0 611 is set to ScalingList[0] 620, scaling list information for slice 1 612 is set to ScalingList[1] 630, and scaling list information for slice 2 613 is set to ScalingList[2] 630. In this case, pieces of scaling list information are different from each other.

In this way, the adaptive inverse quantization unit may adaptively perform inverse quantization on respective partitioned regions using pieces of scaling list information which are separately set for respective partitioned regions.

Further, the pieces of scaling list information may be separately set for respective partitioned regions based on the results of analyzing the visual perception characteristics of an image. Here, the visual perception characteristics may include at least one of a luminance adaptation effect, a contrast sensitivity function effect, and a contrast masking effect.

As described above, the adaptive inverse quantization unit may perform an inverse quantization for a block to be decoded using scaling list information, which is set for a certain region including the block to be decoded.

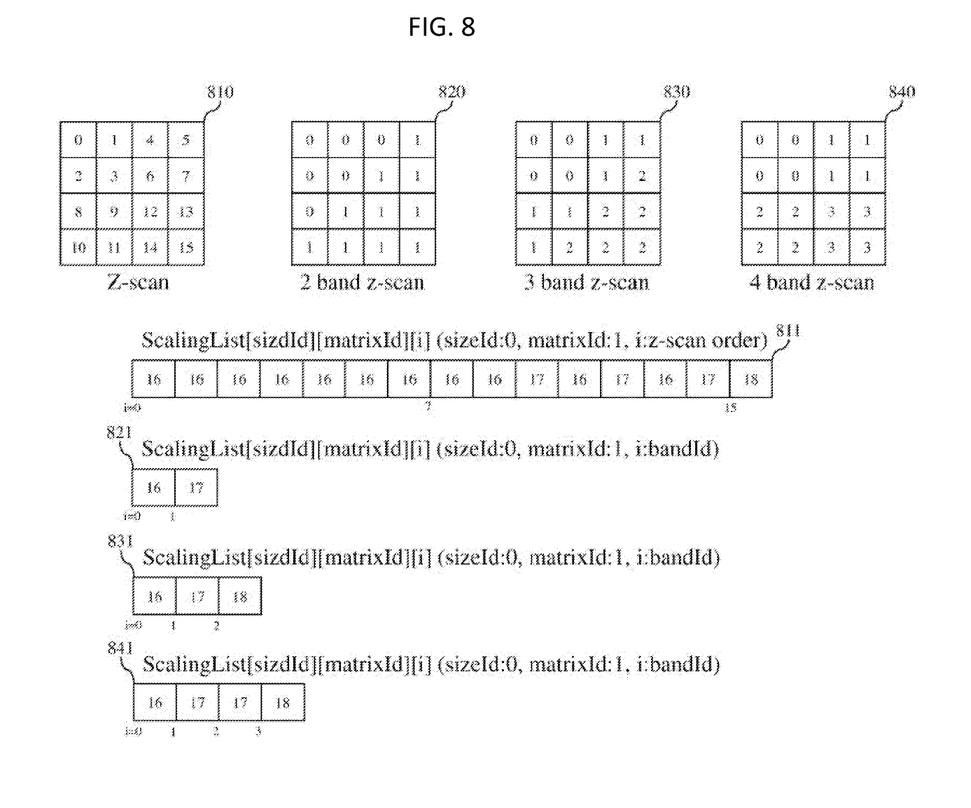

The detailed operation of the adaptive inverse quantization unit will be described below with reference to FIGS. 7 and 8.

FIG. 7 is a diagram showing an example of the scan order and scaling values of blocks to be decoded in the scaling list information.

The adaptive inverse quantization unit may adaptively perform inverse quantization using scaling values that are present in scaling list information set for a certain region including blocks to be decoded in the corresponding image, and may scan the blocks to be decoded according to the scan order indicated in the scaling list information.

Here, scaling values according to an example may be separately set for respective lower blocks constituting a block to be decoded, depending on the frequency characteristics of the lower blocks.

In addition, individual lower blocks constituting a block to be decoded may mean one or more pixels or frequency components, which may be set differently depending on the sizes and domains of lower blocks.

For example, as shown in FIG. 7, a lower block located in a top-left portion has a scaling value of 16, and a lower block located in a bottom-right portion has a scaling value of 18. Each lower block may basically have a scaling value of 16. Generally, based on the fact that, as the position of lower blocks becomes closer to the top-left portion, the lower blocks exhibit low-frequency characteristics, and as the position of lower blocks becomes closer to the bottom-right portion, the lower blocks exhibit high-frequency characteristics, scaling values in scaling list information 730 may be separately set for respective lower blocks.

Further, a scan order according to an example may be a raster order 710 or a Z-scan order 720. In the present invention, the Z-scan order may be preferable. For reference, the numbers 0 to 15, indicated in the lower blocks constituting the block to be decoded, may denote the sequence in which blocks are scanned when following each scan order.

In addition, the block to be decoded may have a size other than a 4*4 size.

FIG. 8 is a diagram showing another example of the scan order and scaling values of blocks to be decoded in the scaling list information.

The adaptive inverse quantization unit may adaptively perform inverse quantization using scaling values that are present in scaling list information set for a certain region including blocks to be decoded in the corresponding image, and may scan the blocks to be decoded according to the scan order indicated in the scaling list information.

Here, scaling values according to another example may be separately set for respective lower block sets (bands), each including two or more lower blocks, depending on the frequency characteristics of the lower blocks constituting the block to be decoded. In this case, the number of lower block bands may be variably determined, and scaling values may be separately set for respective lower block bands depending on the frequency characteristics of the lower block bands.

Further, a scan order according to an example may be separately set for each lower block band, and may follow a Z-scan order.

For example, scaling list information 811 to which the concept of lower block bands is not applied includes scaling values of 16, 17, and 18, respectively set for 16 lower blocks. Also, the numbers 0 to 15, indicated in respective lower blocks constituting the block 810 to be decoded, denote the sequence in which the blocks are scanned when following a Z-scan order.

Further, scaling list information 821 to which two lower block bands are applied includes a scaling value of 16, which is set for a first lower block band that includes six lower blocks located in an upper left portion, and a scaling value of 17, which is set for a second lower block band that includes 10 lower blocks located in a lower right portion. Also, the numbers 0 and 1, indicated in the lower blocks constituting the block 820 to be decoded, denote the sequence in which the blocks are scanned when following a Z-scan order.

Furthermore, scaling list information 831 to which three lower block bands are applied includes a scaling value of 16, which is set for a first lower block band including four lower blocks located in an upper left portion, a scaling value of 17, which is set for a second lower block band including six lower blocks located in a center portion, and a scaling value of 18, which is set for a third lower block band including six lower blocks located in a lower right portion. Also, the numbers 0 to 2, indicated in lower blocks constituting the block 830 to be decoded, denote the sequence in which blocks are scanned when following a Z-scan order.

Furthermore, scaling list information 841 to which four lower block bands are applied includes a scaling value of 16, which is set for a first lower block band including four lower blocks located in an upper left portion, a scaling value of 17, which is individually set for a second lower block band including four lower blocks located in an upper right portion, and for a third lower block band including four lower blocks located in a lower left portion, and a scaling value of 18, which is set for a fourth lower block band including four lower blocks located in a lower right portion. Also, the numbers 0 to 3, indicated in lower blocks constituting the block 840 to be decoded, denote the sequence in which blocks are scanned when following a Z-scan order.

In addition, the block to be decoded may have a size other than a 4*4 size, and thus the size of the lower block band may also vary depending on the size of the block.

Furthermore, the entropy decoding unit may extract pieces of predictive scaling list information and residual scaling list information, separately generated for respective partitioned regions, from a bitstream, and the extracted predictive scaling list information and residual scaling list information may be used by the adaptive inverse quantization unit.

Here, the predictive scaling list information may be selected from scaling list information, which is set for a first region including a block in a reference image temporally coincident (co-located) with a block to be decoded, and scaling list information, which is set for a second region including a neighboring block spatially adjacent to the block to be decoded. The residual scaling list information may be generated from the difference between the predictive scaling list information and scaling list information set for a certain region.

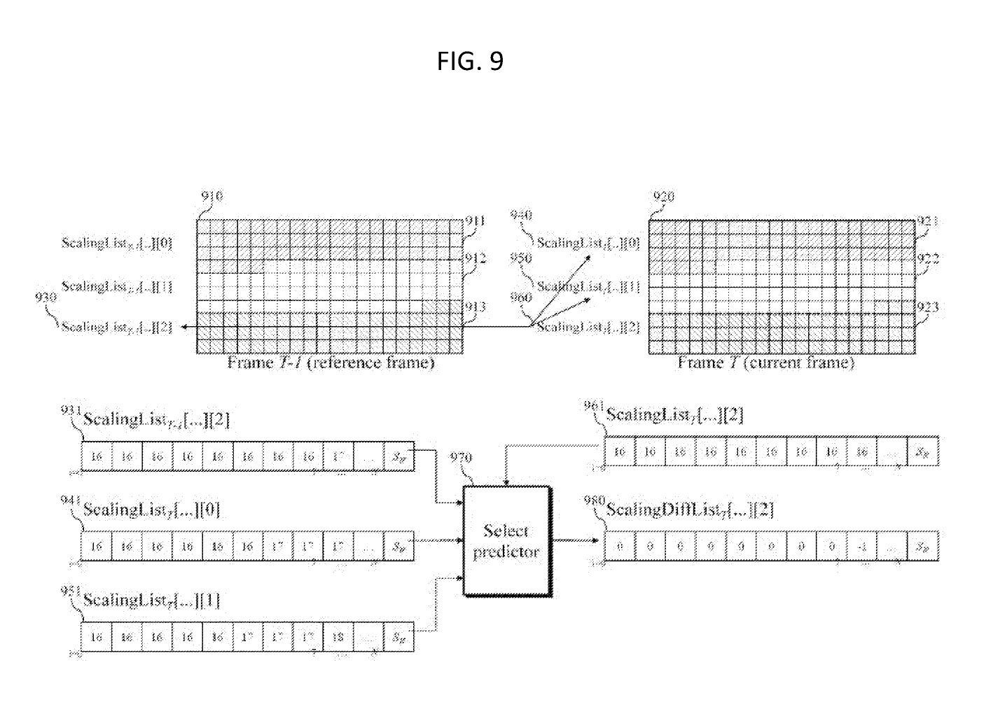

FIG. 9 is a diagram showing an example of residual scaling list information and predictive scaling list information.

Referring to FIG. 9, a certain region 923 including a block to be decoded is shown in the current image (frame) 920. Further, a first region 913 including a block in a reference frame 910, which is temporally coincident with the block to be decoded, and second regions 921 and 922 including neighboring blocks in the current frame 920, which are spatially adjacent to the block to be decoded, are depicted.

Scaling list information 960 set for the certain region 923 is ScalingList_{T}[. . . ] [2] 961, scaling list information 930 set for the first region 913 is ScalingList_{T-1}[. . . ][2] 931, and pieces of scaling list information 940 and 950 set for the respective second regions 921 and 922 are ScalingList_{T}[. . . ][0] 941 and ScalingList_{T}[. . . ][1] 951.

The predictive scaling list information may be selected as one from among ScalingList_{T-1}[. . . ][2] 931, ScalingList_{T}[. . . ][0] 941, and ScalingList_{T}[. . . ][1] 951 by a selector 970. The residual scaling list information ScalingDiffList_{T}[. . . ][2] 980 may be generated from the difference between the selected predictive scaling list information and ScalingList_{T}[. . . ][2] 961. Here, the selector 970 may select scaling list information having the minimum error as the predictive scaling list information.

In addition, FIG. 9 illustrates an example, and thus the predictive scaling list information and residual scaling list information are not limited by the description of the drawing.

Further, the entropy decoding unit may extract flag information indicating whether to perform merging for scaling list information from a bitstream. Here, whether to perform merging may be determined according to the position of a predetermined region in a frame.

For example, when a neighboring region spatially adjacent to a predetermined region is present on the upper or left sides of the predetermined region, the entropy decoding unit may extract flag information indicating that merging for scaling list information in the predetermined region is possible.

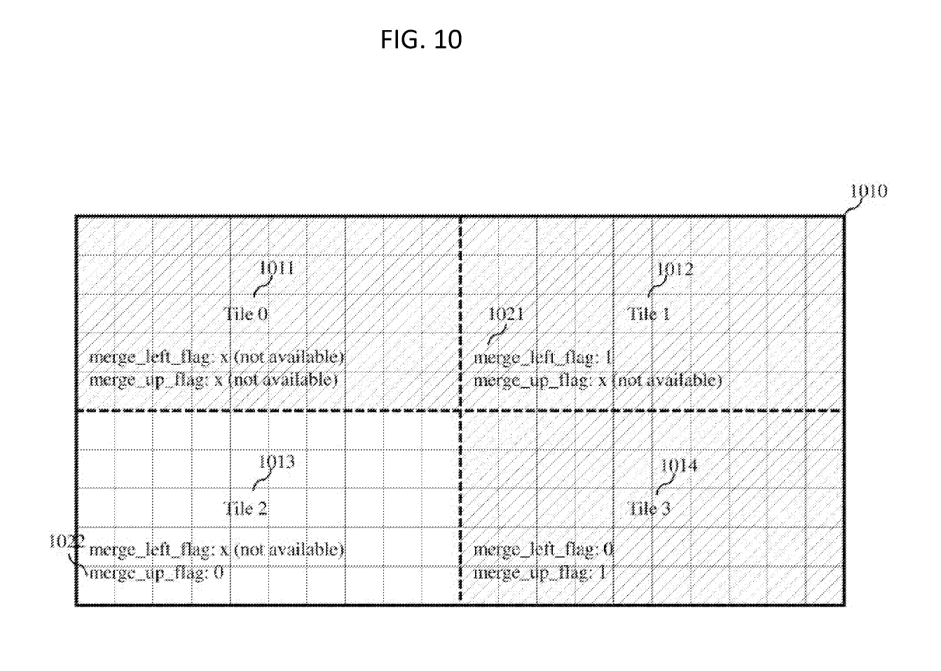

FIG. 10 is a diagram showing an example of merging between pieces of scaling list information.

An image 1010 is partitioned into four tiles, wherein each tile may be a partitioned region in the present invention.

Since tile 0 1011 does not have a tile to be referred to on its upper or left side, merging is not performed.

Since tile 1 1012 has tile 0 1011 on its left side, whether to merge scaling list information with that of tile 0 1011 is determined, and this determination is indicated using a left merge flag merge left flag 1021.

Since tile 2 1013 has tile 0 1011 on its upper side, whether to merge scaling list information with that of tile 0 1011 is determined, and this determination is indicated using an upper merge flag merge up flag 1022.

Since tile 3 1014 has tile 1 1012 and tile 2 1013 on its upper and left sides, respectively, whether to merge scaling list information with those of tiles 1 and 2 is determined, and this determination is indicated using a left merge flag and an upper merge flag.

For reference, flag information of 1 may mean that merging is performed, and flag information of 0 may mean that merging is not performed, but such flag information may be set to have opposite meanings.

In this way, the video encoding/decoding apparatus proposed in the present invention may improve the subjective quality of video to be compressed/reconstructed, and may reduce the amount of scaling list information that is transmitted in encoding/decoding, thus contributing to the improvement of coding efficiency.

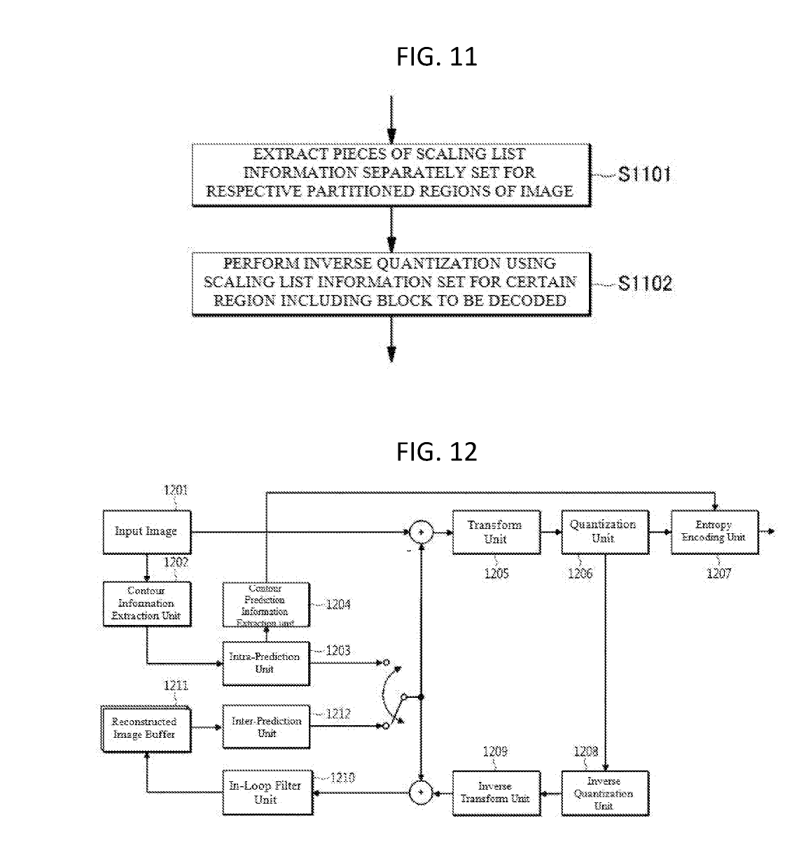

Hereinafter, a video decoding method will be described with reference to FIG. 11. FIG. 11 is a flowchart showing a video decoding method according to an embodiment of the present invention. For this, the above-described video decoding apparatus may be utilized, but the present invention is not limited thereto. However, the method for decoding video using the video decoding apparatus will be described for the convenience of description.

First, in a video decoding method according to the embodiment of the present invention, pieces of scaling list information separately set for respective partitioned regions of an image are extracted from a bitstream (S1101).

Next, inverse quantization is performed on a block to be decoded using scaling list information, which is set for a certain region including the block to be decoded in the image, among the pieces of scaling list information that are extracted (S1102).

Individual steps will be described in detail below.

In accordance with an example, at the extraction step S1101, pieces of predictive scaling list information and pieces of residual scaling list information that are separately generated for respective partitioned regions are extracted.

In this case, a predicted signal corresponding to the block to be decoded may be generated based on the predictive scaling list information and the residual scaling list information.

Here, the predictive scaling list information is selected from scaling list information, which is set for the block in a reference image temporally adjacent with the block to be decoded, and scaling list information, which is set for a neighboring block spatially adjacent to the block to be decoded. The residual scaling list information is generated from the difference between the predictive scaling list information and the set scaling list information.

Further, in accordance with another example, at the extraction step S1101, flag information indicating whether to perform merging for scaling list information may be extracted.

In this case, whether to perform merging may be determined based on flag information as to whether scaling list information set for the certain region has been merged with scaling list information set for another region.

Here, whether to perform merging may be determined according to the position of a predetermined region in the image.

Meanwhile, according to an example, at the step S1102 of performing inverse quantization, inverse quantization may be performed using scaling values in the scaling list information set for the certain region including the block to be decoded.

Here, the scaling values may be separately set for respective lower blocks constituting the block to be decoded, depending on the frequency characteristics of the lower blocks.

Further, according to another example, at the step S1102 of performing inverse quantization, inverse quantization may also be performed using scaling values in the scaling list information, which is set for the certain region including the block to be decoded.

In this case, the scaling values may be separately set for respective lower block bands, each including two or more lower blocks, depending on the frequency characteristics of lower blocks constituting the block to be decoded, and the number of lower block bands may be variously determined.

As described above, when the video encoding/decoding method proposed in the present invention is utilized, it is possible to improve the subjective quality of video to be compressed/reconstructed and to reduce the amount of scaling list information that is transmitted in encoding/decoding, thus contributing to the improvement of coding efficiency.

Meanwhile, FIG. 12 is a block diagram showing the overall configuration of a video encoding apparatus according to another embodiment of the present invention.

The video encoding apparatus according to another embodiment of the present invention uses partition information or contour information of a corresponding region in a previously encoded area, which corresponds to the current block to be encoded, as a predicted signal for the current block, so that the current block is encoded in an intra-prediction mode or a partial block copy mode, and a predicted signal for the current block is extracted and encoded.

The video encoding apparatus according to another embodiment of the present invention may include a contour information extraction unit 1202, an intra-prediction unit 1203, a contour prediction information extraction unit 1204, a transform unit 1205, a quantization unit 1206, an entropy encoding unit 1207, an inverse quantization unit 1208, an inverse transform unit 1209, an in-loop filter unit 1210, a reconstructed image buffer 1211, and an inter-prediction unit 1212.

The contour information extraction unit 1202 may detect and analyze contour (edge) information about an input image 1201, and may transfer the results of detection and analysis to the intra-prediction unit 1203.

The intra-prediction unit 1203 may perform intra prediction based on intra-picture prediction techniques including MPEG-4, H.264/AVC, and HEVC, and may additionally perform contour-based prediction on a previously encoded area based on the contour information extracted by the contour information extraction unit 1202.

The contour prediction information extraction unit 1204 extracts intra-prediction mode information determined by the intra-prediction unit 1203, the position of a contour prediction signal, contour prediction information, etc.

The quantization unit 1206 may quantize a residual signal transformed by the transform unit 1205, and may transfer the quantized residual signal to the entropy encoding unit 1207.

The entropy encoding unit 1207 may generate a bitstream by compressing the information quantized by the quantization unit 1206 and the information extracted by the contour prediction information extraction unit 1204.

The inter-prediction unit 1212 may perform inter-prediction mode-based prediction using the information stored in the reconstructed image buffer 1211 through the in-loop filter unit 1210. The quantized transform signal, output from the quantization unit 1206, is inversely quantized and inversely transformed by the inverse quantization unit 1208 and the inverse transform unit 1209, and is then transferred together with the prediction signal output from the intra-prediction unit 1203 or the inter-prediction unit 1212 to the in-loop filter unit 1210.

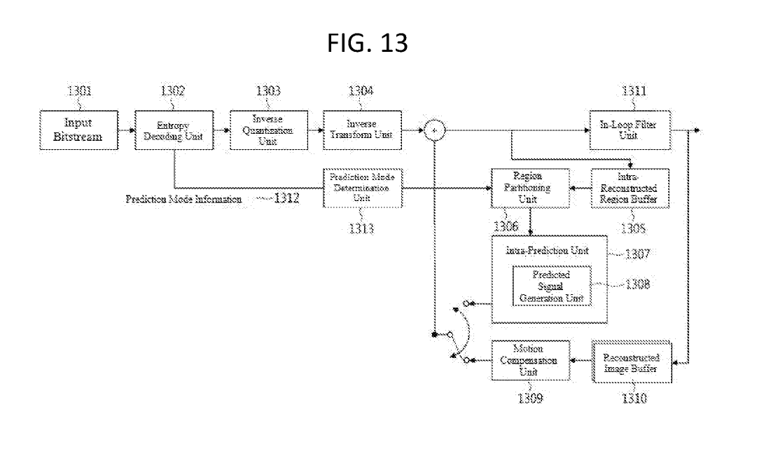

FIG. 13 is a block diagram showing the overall configuration of a video decoding apparatus according to another embodiment of the present invention.

The video decoding apparatus according to another embodiment of the present invention includes an entropy decoding unit 1302, an inverse quantization unit 1303, an inverse transform unit 1304, an intra-reconstructed region buffer 1305, a region partitioning unit 1306, an intra-prediction unit 1307, a predicted signal generation unit 1308, a motion compensation unit 1309, a reconstructed image buffer 1310, an in-loop filter unit 1311, and a prediction mode determination unit 1313.

The entropy decoding unit 1302 may decode a bitstream 1301 transmitted from the video encoding apparatus, and may output decoding information including both syntax elements and quantized transform coefficients.

The prediction mode for the current block to be decoded may be determined by the prediction mode determination unit 1313 based on the prediction mode information 1312 in the extracted syntax elements, and the quantized transform coefficients may be inversely quantized and inversely transformed into a residual signal through the inverse quantization unit 1303 and the inverse transform unit 1304.

The predicted signal may be generated based on an intra-prediction mode implemented by the intra-prediction unit 1307 or an inter-prediction mode implemented by the motion compensation unit 1309, and may also be generated based on an intra-partial block copy mode in the present invention.

The intra-prediction unit 1307 may perform spatial prediction using the pixel values of the current block to be decoded and a neighboring block spatially adjacent to the current block, and may then generate a predicted signal for the current block.

The region partitioning unit 1306, for which whether an operation is to be performed is determined differently based on the results of the determination by the prediction mode determination unit 1313, may partition a corresponding region, which corresponds to the current block, based on a signal related to a reconstructed region (reconstructed signal) input from the intra-reconstructed region buffer 1305. A detailed description thereof will be made later.

The reconstructed signal may be generated by adding the predicted signal, generated by at least one of the intra-prediction unit 1307, a predicted signal generation unit 1308 included therein, and the motion compensation unit 1309, to the above-described residual signal, and may be finally reconstructed using the in-loop filter unit 1311.

The in-loop filter unit 1311 may output a reconstructed block by performing deblocking filtering, an SAO procedure, or the like, and the reconstructed image buffer 1310 may store the reconstructed block. Here, the reconstructed block may be used as a reference image by the motion compensation unit 1309 for an inter-prediction mode.

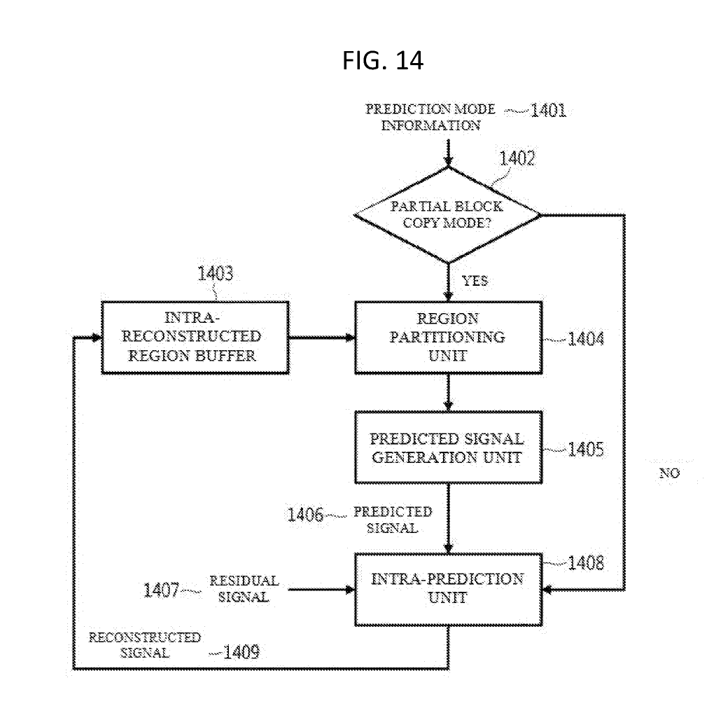

FIG. 14 is a diagram showing in detail the operation of some of the components shown in FIG. 13.

The video decoding apparatus according to another embodiment of the present invention may include a region partitioning unit 1404 and a predicted signal generation unit 1405.

The region partitioning unit 1404 may receive the results of the determination by the prediction mode determination unit, based on prediction mode information 1401 received from a bitstream.

When the current block to be decoded is encoded in an (intra) partial block copy mode, among the intra-prediction modes, the region partitioning unit 1404 may partition a corresponding region in a previously decoded area, which corresponds to the current block, into an arbitrary shape. Here, information related to the previously decoded area may be stored in an intra-reconstructed region buffer 1403.

More specifically, the region partitioning unit 1404 may partition the corresponding region into two or more sub-regions using a curve or a straight line. In this way, since the region partitioning unit 1404 may partition the corresponding region into an arbitrary shape, the region may be adaptively partitioned depending on image characteristics (e.g. screen content divided into a text (subtitles) region and a video region).

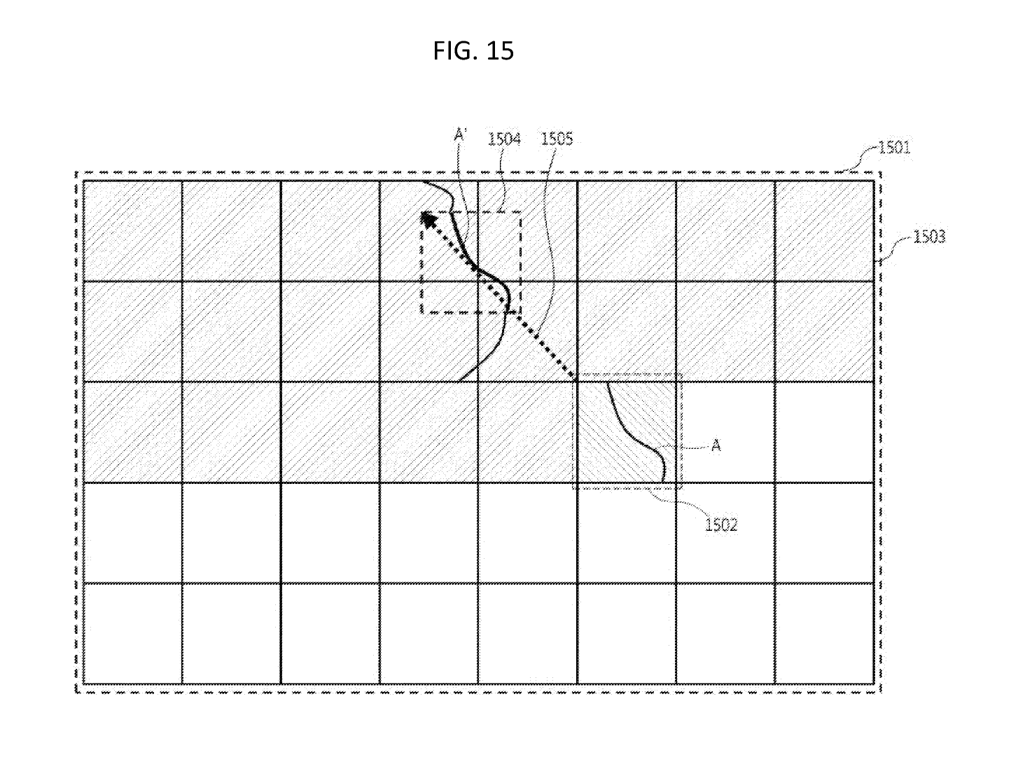

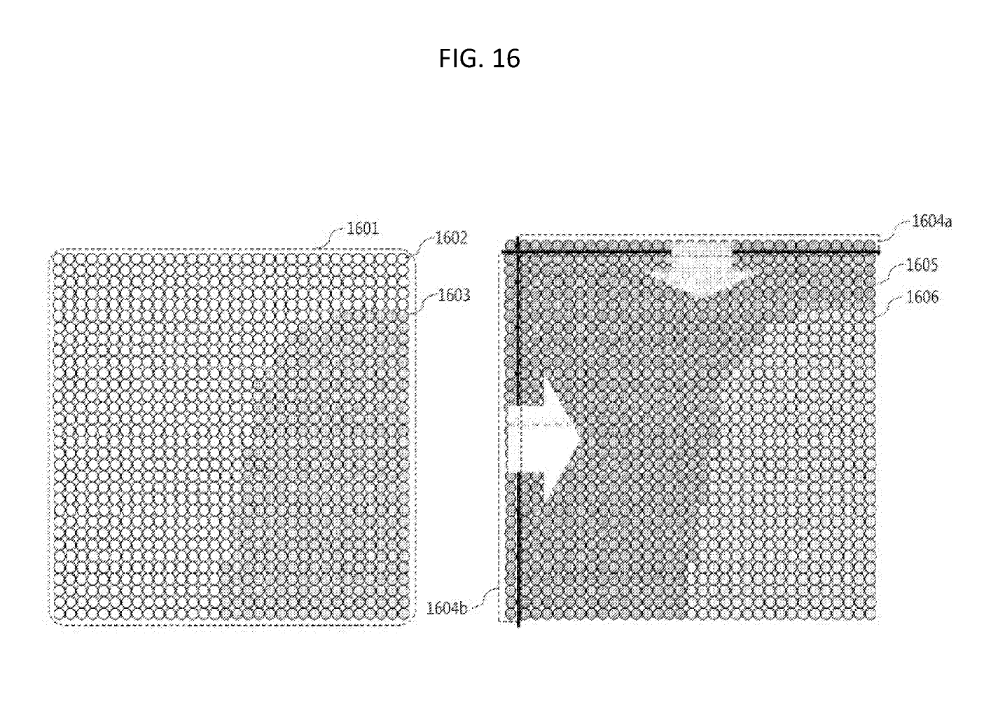

FIG. 15 is a diagram showing an example of the current block to be decoded and a corresponding region in a previously decoded area.

The current block 1502 to be decoded in an arbitrary picture 1501 and the corresponding region 1504 in the previously decoded area have a corresponding relationship with each other.

The region partitioning unit 1404 may search for the corresponding region 1504 based on a block vector 1505, which is information about the relative positions of the current block 1502 and the corresponding region 1504, and may partition the searched corresponding region 1504.

In particular, the region partitioning unit 1404 may partition the corresponding region 1504 based on the geometric properties of the searched corresponding region 1504.

More specifically, the region partitioning unit 1404 according to an example may partition the corresponding region 1504 based on a specific contour A′ or a strong edge component contained in the searched corresponding region 1504. Here, the specific contour A′ is one of respective contours contained in a plurality of lower regions forming a previously decoded area 1503, and may be determined based on the results of analyzing the similarities between the respective contours and a contour A contained in the current block 1502. That is, the lower region containing the contour having the highest similarity may be the corresponding region 1504, and algorithms for analyzing similarities may be variously applied.

Further, the region partitioning unit 1404 according to another example may partition the corresponding region 1504 based on the distribution of predetermined pixel values in the searched corresponding region 1504. Here, the distribution of predetermined pixel values is one of respective distributions of pixel values in a plurality of lower regions constituting the previously decoded area 1503, and may be determined based on the results of analyzing the similarities between the respective pixel value distributions and the distribution of pixel values in the current block 1502. That is, a lower region having a pixel value distribution having the highest similarity may be the corresponding region 1504, and algorithms for analyzing the similarities may be variously applied.

Referring back to FIG. 14, the predicted signal generation unit 1405 may generate respective predicted signals for the current block (or corresponding region) based on an intra-prediction mode or an intra-block copy mode for respective corresponding regions partitioned by the above-described region partitioning unit 1404.

More specifically, the predicted signal generation unit 1405 may generate an intra-prediction mode-based predicted signal 1406 for a region for which the previously decoded area is adjacent to at least one of the left and upper sides of the region, among the partitioned corresponding regions, and may generate an intra-block copy mode-based predicted signal 1406 for a region for which the previously decoded area is not adjacent to the left and upper sides of the region, among the partitioned corresponding regions.

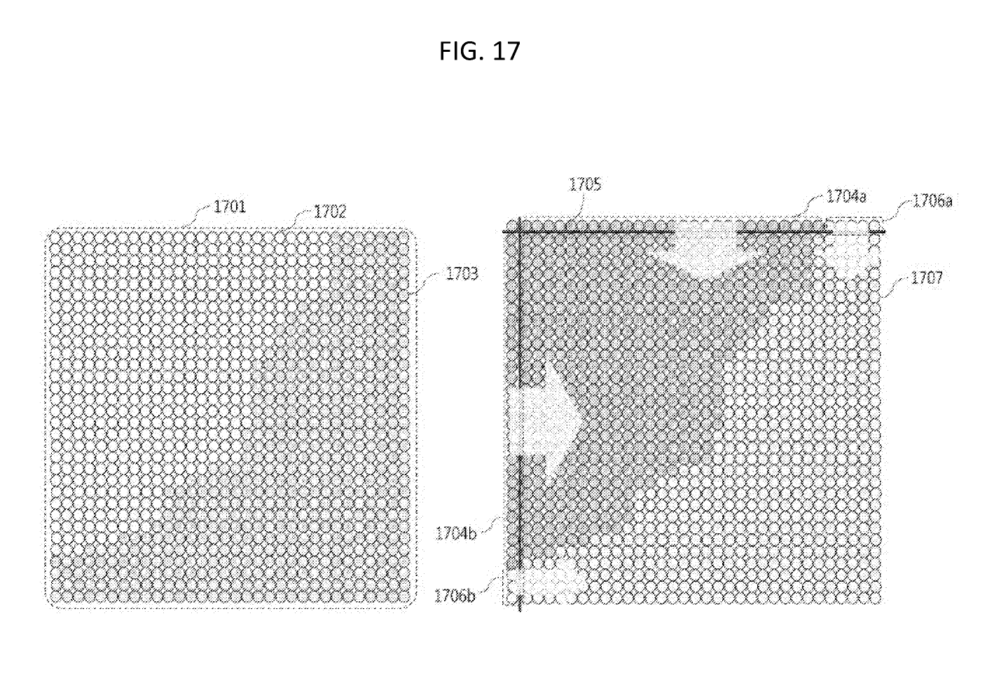

That is, the predicted signal generation unit 1405 may adaptively apply the intra-prediction mode or the intra-block copy mode to each of corresponding regions partitioned into an arbitrary shape, thus improving intra-prediction performance. In relation to this, a description will be made with reference to FIGS. 16 and 17.

FIG. 16 is a diagram showing examples of a partitioned corresponding region, and regions decoded in an intra-prediction mode and an intra-block copy mode.

Referring to FIG. 16, the region partitioning unit partitions a corresponding block 1601, which corresponds to the current block, into a first region 1602 and a second region 1603 based on predetermined criteria (contour, pixel value distribution, or the like).

Here, referring to a drawing shown on the right side, it can be seen that previously decoded areas 1604a and 1604b are adjacent to the left side and the upper side of a first region 1605, and are not adjacent to the left side and upper side of a second region 1606.

Therefore, the predicted signal generation unit generates an intra-prediction mode-based predicted signal for the first region 1605, and a block copy mode-based predicted signal for the second region 1606.

FIG. 17 is a diagram showing examples of a partitioned corresponding region and a region decoded in an intra-prediction mode.

Referring to FIG. 17, the region partitioning unit partitions a corresponding block 1701, which corresponds to the current block, into a third region 1702 and a fourth region 1703 based on predetermined criteria (e.g. contour, pixel value distribution, or the like).

Here, referring to a drawing shown on a right side, it can be seen that portions 1704a and 1704b of a previously decoded area are adjacent to the left and upper sides of a third region 1705 and the remaining portions 1706a and 1706b of the previously decoded area are adjacent to the left and upper sides of a fourth region 1707.

Therefore, the predicted signal generation unit generates intra-prediction mode-based predicted signals for the third region 1705 and the fourth region 1707.

Referring back to FIG. 14, the predicted signal 1406 generated by the above-described predicted signal generation unit 1405 and the residual signal 1407 received from a bitstream are added to each other by the intra-prediction unit 1408, and then form a reconstructed signal 1409. The reconstructed signal 1409 for the current block (or the corresponding block) may include information related to the reconstructed image or block, may be stored in the intra-reconstructed region buffer 1403, and may also be used for region partitioning for a block to be subsequently decoded.

Meanwhile, as described above, the region partitioning unit 1404 may receive the results of the determination by the prediction mode determination unit. That is, the video decoding apparatus according to another embodiment of the present invention may further include a prediction mode determination unit 1313 (see FIG. 13), in addition to the above-described region partitioning unit 1404 and predicted signal generation unit 1405.

More specifically, the prediction mode determination unit may determine whether the current block has been encoded in a partial block copy mode using flag information extracted from a bitstream (1402).

For example, when flag information is represented by “partial_intra_bc_mode”, if a bit value in the flag information of an X block is 1, the X block has been encoded in a partial block copy mode, whereas if the bit value is 0, the X block has not been encoded in the partial block copy mode. Of course, depending on the situation, the bit value in the flag information may have meanings opposite thereto.

Here, the flag information may be included either in a Picture Parameter Set (PPS) for the picture group or picture that includes the current block, or in a slice header for the slice or slice segment that includes the current block.

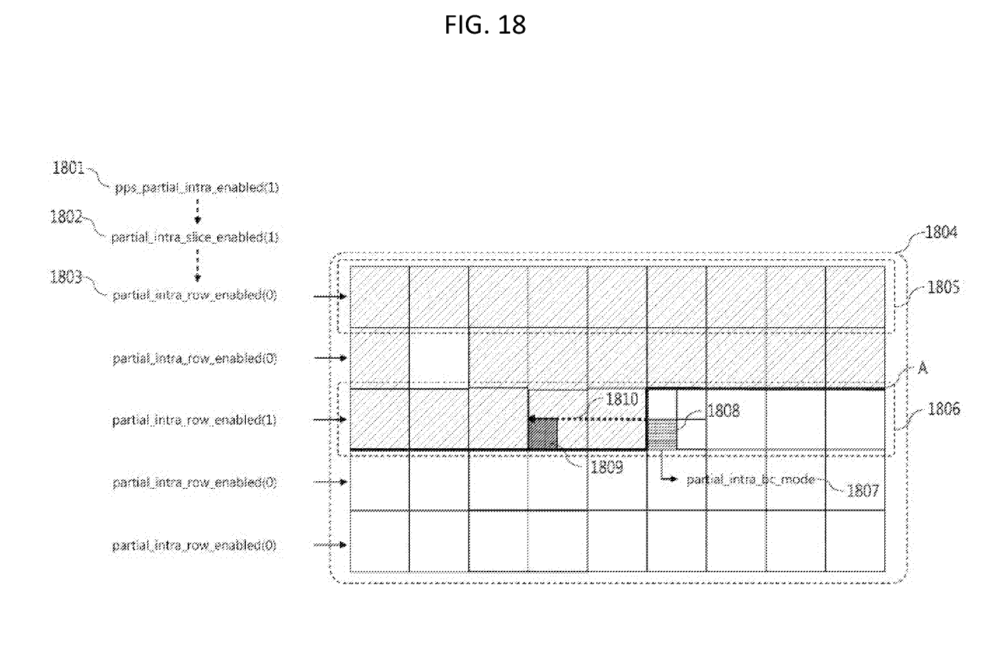

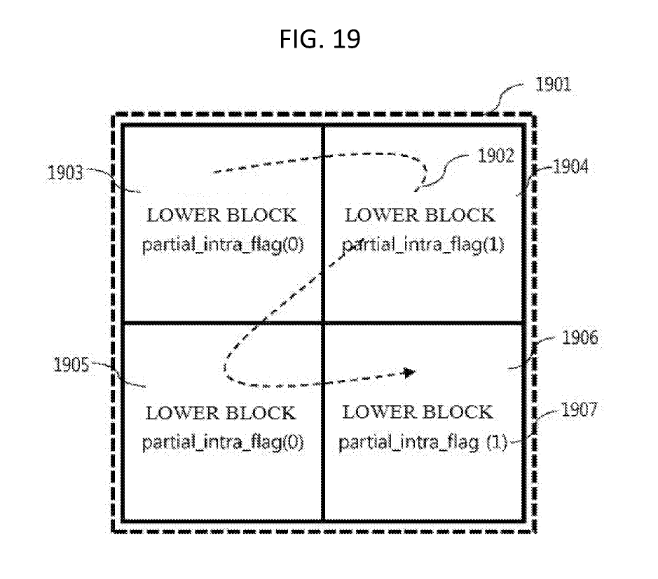

Hereinafter, to describe the detailed operation of the prediction mode determination unit, a description will be made with reference to FIGS. 18 and 19.

FIG. 18 is a diagram showing examples of region flag information, a plurality of target blocks that are spatially adjacent to each other and constitute an arbitrary row, and lower blocks contained in each target block.

The prediction mode determination unit may determine, using region flag information extracted from a bitstream, whether each of lower blocks contained in the plurality of target blocks that are spatially adjacent to each other and constitute an arbitrary row or column has its own flag information, for each row or column. In this case, the flag information may indicate whether the lower block has been encoded in a partial block copy mode.

Unlike flag information used to determine whether each individual block has been encoded in a partial block copy mode, the region flag information may be used to determine whether each individual block having the above-described flag information is present in a certain region. Such region flag information is described in high-level syntax, such as a picture parameter set level 1801 or a slice header level 1802, and may then be used to signal whether prediction based on a partial block copy mode has been performed.

For example, when the value of region flag “pps_partial_intra_enabled” 1801 is 0, the prediction mode determination unit may determine that none of the blocks in the current picture 1804 are encoded in a partial block copy mode. Further, when the value of the region flag “pps_partial_intra_enabled” 1801 is 1, the prediction mode determination unit may determine that all or some of the blocks in the current picture 1804 have the above-described flag information. Of course, depending on the circumstances, the region flag may have meanings opposite thereto.

For example, when the value of region flag “partial_intra_row_enabled” 1803 is 0, the prediction mode determination unit may determine that none of the blocks in the current row 1805 are encoded in a partial block copy mode. Further, when the value of the region flag “partial_intra_row_enabled” is 1, the prediction mode determination unit may determine that all or some of the blocks in the current row 1806 have the above-described flag information. Further, when the value of flag “partial_intra_bc_mode” 1807 of a predetermined lower block 1808 contained in the current row 1806 is 1, the region partitioning unit may partition a corresponding region 1809, which corresponds to a lower block 1808, in a previously decoded area located in an upper left portion with respect to line A, into an arbitrary shape. Here, in order to search for the corresponding region 1809, a block vector 1810 may be used, and the lower block 1808 or the corresponding region 1809 may be partitioned based on predetermined criteria (contour, pixel value distribution, or the like).

Furthermore, FIG. 19 is a diagram showing an example of a procedure in which the current block composed of unit blocks having a minimum size is decoded.

When the current block is a unit block 1901 having a minimum size, the prediction mode determination unit may determine, using partial flag information “partial_intra_flag” 1907 extracted from a bitstream, whether each of lower blocks 1903, 1904, 1905, and 1906 contained in a unit block has been encoded in a partial block copy mode, for each lower block. Here, the unit block is a block having a minimum size that is not divided any further for coding, and the partial flag information may be the kind of flag information.

Further, the prediction mode determination unit may determine whether lower blocks have been individually encoded in a partial block copy mode according to a z-scan order 1902. The second and fourth lower blocks 1904 and 1905, having the flag “partial_intra_flag” value of 1, are encoded in a partial block copy mode, and the first and third lower blocks 1903 and 1906, having the flag “partial_intra_flag” value of 0, are not encoded in a partial block copy mode, and may then be determined to be encoded in an existing intra-prediction mode.

In this way, the video decoding apparatus proposed in the present invention may adaptively generate predicted signals based on an intra-prediction mode or an intra-block copy mode for respective partitioned regions, thus improving the overall intra-prediction performance, and optimally reflecting the geometric characteristics of video when the video is compressed/reconstructed.

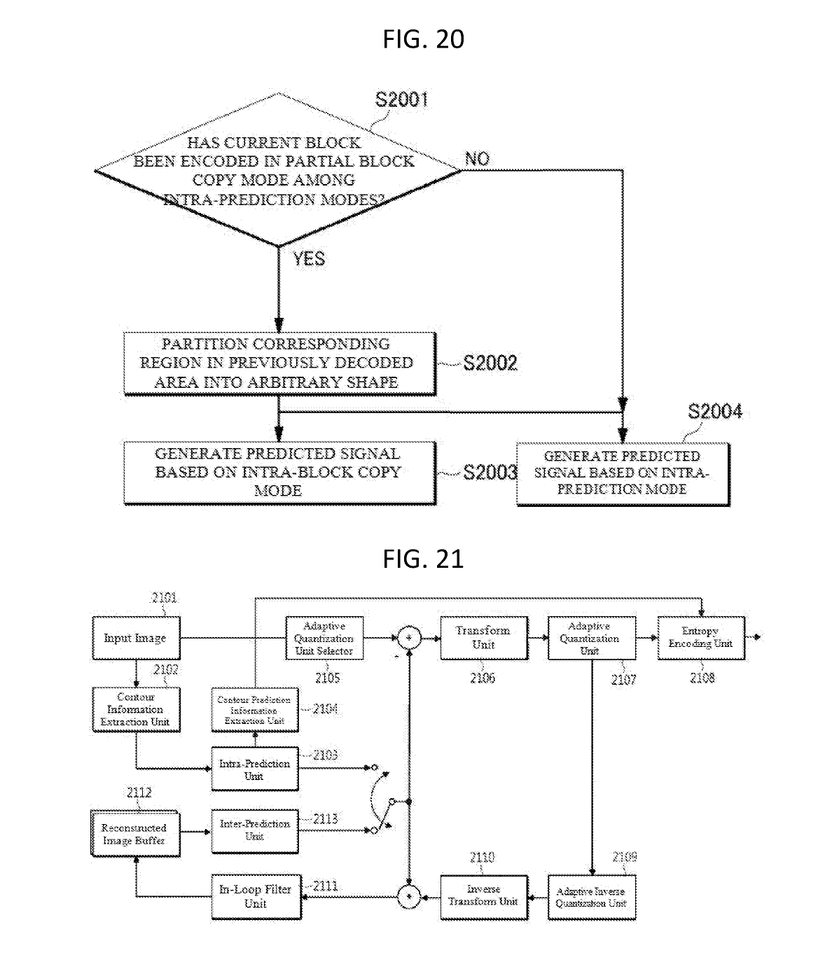

Meanwhile, a video decoding method will be described below with reference to FIG. 20. FIG. 20 is a flowchart showing a video decoding method according to another embodiment of the present invention. For this, the above-described video decoding apparatus may be utilized, but the present invention is not limited thereto. However, for the convenience of description, a method for decoding video using the video decoding apparatus will be described below.

In the video decoding method according to another embodiment of the present invention, it is determined whether the current block to be decoded has been encoded in a partial block copy mode among intra-prediction modes (S2001).

In detail, at the determination step S2001, it may be determined, using flag information extracted from a bitstream, whether the current block has been encoded in a partial block copy mode.

More specifically, at the determination step S2001, whether each of lower blocks contained in a plurality of target blocks that are spatially adjacent to each other and constitute an arbitrary row or column has its own flag information may be determined for each row or column based on region flag information extracted from a bitstream. Here, the flag information may indicate whether the corresponding lower block has been encoded in a partial block copy mode.

Further, at the determination step S2001, when the current block is a unit block having a minimum size, it may be determined, using partial flag information extracted from the bitstream, whether each lower block contained in the unit block has been encoded in a partial block copy mode.

Then, when the lower block has been encoded in the partial block copy mode (i.e. in the case of Yes), a corresponding region, which corresponds to the current block, in a previously decoded area is partitioned into an arbitrary shape (S2002).

Here, the corresponding region may be partitioned into two or more sub-regions using a curve or a straight line.

In detail, the partitioning step S2002 may include the step of searching for a corresponding region based on a block vector, which is information about the relative positions of the current block and the corresponding region, and the searched corresponding region may be partitioned.

More specifically, at the partitioning step S2002 according to an example, the corresponding region may be partitioned based on a predetermined contour contained in the corresponding region. Here, the predetermined contour is one of respective contours contained in a plurality of lower regions constituting a previously decoded area, and may be determined based on the results of analyzing the similarities between respective contours and the contour contained in the current block.

Further, at the partitioning step S2002 according to another example, the corresponding region may be partitioned based on the distribution of predetermined pixel values in the corresponding region. Here, the distribution of predetermined pixel values is one of respective distributions of pixel values in a plurality of lower regions constituting the previously decoded area, and may be determined based on the results of analyzing the similarities between the respective pixel value distributions and the distribution of pixel values in the current block.

For reference, when the lower block has not been encoded in the partial block copy mode (i.e. in the case of No), a predicted signal for the current block may be generated based on an intra-prediction mode (S2004).

Next, for each corresponding region partitioned at partitioning step S2002, a predicted signal for the current block (or the corresponding block) based on an intra-prediction mode is generated (S2004), or a predicted signal for the current block (or the corresponding block) based on an intra-block copy mode is generated (S2003).

More specifically, at the generating step S2004, a predicted signal based on the intra-prediction mode may be generated for a region for which the previously decoded area is adjacent to at least one of the left and upper sides of the region, among the partitioned corresponding regions.

Further, at the generating step S2003, a predicted signal based on the intra-block copy mode may be generated for a region for which a previously decoded area is not adjacent to the left and upper sides of the region, among the partitioned corresponding regions.

As described above, when the video decoding method proposed in the present invention is utilized, predicted signals based on an intra-prediction mode or an intra-block copy mode may be adaptively generated for respective partitioned regions, thus improving overall intra-prediction performance and optimally reflecting the geometric characteristics of video when the video is compressed/reconstructed.

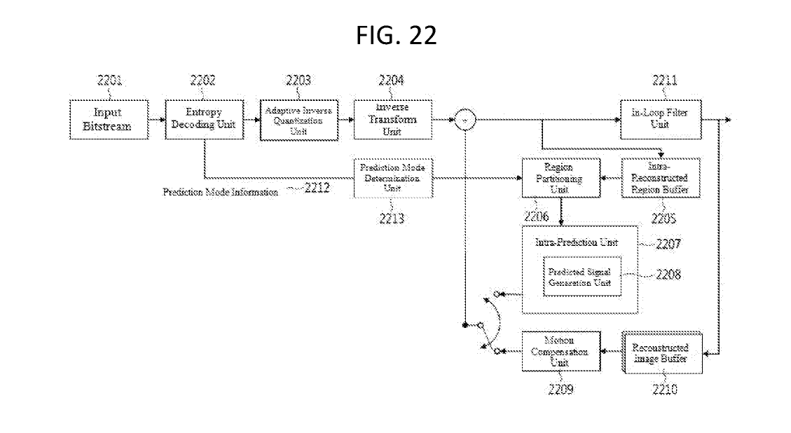

Hereinafter, a video encoding/decoding apparatus according to a further embodiment of the present invention will be described in detail with reference to FIGS. 21 and 22.

FIG. 21 is a block diagram showing the overall configuration of a video encoding apparatus according to a further embodiment of the present invention. The video encoding apparatus according to the further embodiment of the present invention may have a form in which the features of the video encoding apparatus according to one embodiment of the present invention and the features of the video encoding apparatus according to another embodiment of the present invention are combined with each other.

The video encoding apparatus according to the further embodiment of the present invention includes a contour information extraction unit 2102, an intra-prediction unit 2103, a contour prediction information extraction unit 2104, an adaptive quantization unit selector 2105, a transform unit 2106, an adaptive quantization unit 2107, an entropy encoding unit 2108, an adaptive inverse quantization unit 2109, an inverse transform unit 2110, an in-loop filter unit 2111, a reconstructed image buffer 2112, and an inter-prediction unit 2113.

The contour information extraction unit 2102 may detect and analyze contour (edge) information about an input image 2101 and transfer the results of the detection and analysis to the intra-prediction unit 2103.

The intra-prediction unit 2103 may perform intra prediction based on intra-picture prediction techniques including MPEG-4, H.264/AVC, and HEVC, and may additionally perform contour-based prediction on a previously encoded area based on the contour information extracted by the contour information extraction unit 2102.

The contour prediction information extraction unit 2104 extracts intra-prediction mode information determined by the intra-prediction unit 2103, the position of a contour prediction signal, contour prediction information, etc., and transfers the extracted information to the entropy encoding unit 2108.

The adaptive quantization unit selector 2105 may classify regions on which adaptive quantization is to be performed by analyzing the visual perception characteristics of the input image 2101, and may select the structure of an image partition for which scaling list information is to be transmitted.

The adaptive quantization unit 2107 may analyze the visual perception characteristics of a residual signal transformed by the transform unit 2106 based on the results of prediction, and may perform preference prediction on the scaling list information based on temporally or spatially neighboring image partitions.

Further, the adaptive quantization unit 2107 may perform adaptive quantization on the transformed signal using the predicted scaling list information, and may determine whether to merge the corresponding scaling list information with that of the temporally or spatially neighboring image partitions.

The inter-prediction unit 2113 may perform inter-prediction mode-based prediction based on the image partition structure selected by the adaptive quantization unit selector 2105.

The inter-prediction unit 2113 may execute an inter-prediction mode using the information stored in the reconstructed image buffer 2112 through the in-loop filter unit 2111. The quantized transform signal, output from the above-described adaptive quantization unit 2107, may be adaptively inversely quantized, and may be inversely transformed through the adaptive inverse quantization unit 2109 and the inverse transform unit 2110, and is then transferred, together with the predicted signal output from the intra-prediction unit 2103 or the inter-prediction unit 2113, to the in-loop filter unit 2111.

Pieces of encoding information including the quantized transform signal and the information extracted from the contour prediction information extraction unit 2104 are output in the form of a bitstream through the entropy encoding unit 2108.

When the video encoding apparatus and the video encoding method using the apparatus are utilized, the subjective quality of compressed video may be improved, and the amount of scaling list information that is transmitted in encoding may be reduced, thus contributing to the improvement of coding efficiency. Further, the present invention may adaptively generate predicted signals in an intra-prediction mode or an intra-block copy mode for respective partitioned regions, thus improving overall intra-prediction performance and optimally reflecting the geometric characteristics of video when the video is compressed/reconstructed.

FIG. 22 is a block diagram showing a video decoding apparatus according to a further embodiment of the present invention. The video decoding apparatus according to the further embodiment of the present invention may have a form in which the features of the video decoding apparatus according to one embodiment of the present invention and the features of the video decoding apparatus according to another embodiment of the present invention are combined with each other.

The video decoding apparatus according to the further embodiment of the present invention may include an entropy decoding unit 2202, an adaptive inverse quantization unit 2203, an inverse transform unit 2204, an intra-reconstructed region buffer 2205, a region partitioning unit 2206, an intra-prediction unit 2207, a predicted signal generation unit 2208, a motion compensation unit 2209, a reconstructed image buffer 2210, an in-loop filter unit 2211, and a prediction mode determination unit 2213.

The entropy decoding unit 2202 may decode a bitstream 2201 transmitted from the video encoding apparatus, and may output decoding information including syntax elements and quantized transform coefficients.

The adaptive inverse quantization unit 2203 may adaptively perform inverse quantization using both the quantization coefficients and the scaling list information corresponding to an image partition, among pieces of information decoded by the entropy decoding unit 2202.

Further, the adaptive inverse quantization unit 2203 may perform inverse quantization on a block to be decoded using scaling list information set for a certain region including the block to be decoded in the corresponding image, among pieces of scaling list information which are separately set for respective partitioned regions of the image.

The quantized transform coefficients may be inversely quantized and inversely transformed into a residual signal through the adaptive inverse quantization unit 2203 and the inverse transform unit 2204.

Further, the prediction mode for the current block to be decoded may be determined by the prediction mode determination unit 2213 based on prediction mode information 2212 in syntax elements extracted by the entropy decoding unit 2202.

The prediction mode determination unit 2213 may identify the prediction mode in which the current block was encoded based on the prediction mode information, among the pieces of decoding information.

The region partitioning unit 2206, for which whether an operation is to be performed is determined differently based on the results of the determination by the prediction mode determination unit 2213, may partition a corresponding region, which corresponds to the current block, based on a signal related to the reconstructed region (reconstructed signal), input from the intra-reconstructed region buffer 2205.

Here, the reconstructed signal may be generated by adding the predicted signal, generated by at least one of the intra-prediction unit 2207, the predicted signal generation unit 2208 included therein, and the motion compensation unit 2209, to the above-described residual signal, and may be finally reconstructed using the in-loop filter unit 2211.

The in-loop filter unit 2211 may output a reconstructed block by performing deblocking filtering, an SAO procedure, etc., and the reconstructed image buffer 2210 may store the reconstructed block. Here, the reconstructed block may be used as a reference image by the motion compensation unit 2209 in order to execute an inter-prediction mode.

Meanwhile, the predicted signal may be generated based on an intra-prediction mode implemented by the intra-prediction unit 2207 or an inter-prediction mode implemented by the motion compensation unit 2209, and may also be generated based on an intra-partial block copy mode depending on the circumstances.

The intra-prediction unit 2207 may perform spatial prediction using the pixel values of neighboring blocks that are spatially adjacent to the current block to be decoded, and may then generate a predicted signal for the current block.

When the video decoding apparatus and the video decoding method using the apparatus are utilized, the subjective quality of reconstructed video may be improved, and the amount of scaling list information that is transmitted in decoding may be reduced, thus contributing to the improvement of coding efficiency. Further, the present invention may adaptively generate predicted signals based on an intra-prediction mode or an intra-block copy mode for respective partitioned regions, thus improving overall intra-prediction performance and optimally reflecting the geometric characteristics of video when the video is reconstructed.

Meanwhile, respective components shown in FIGS. 1 to 4, 12, 13, 21, and 22 may be implemented as kinds of ‘modules’. The term ‘module’ means a software component or a hardware component, such as a Field Programmable Gate Array (FPGA) or an Application Specific Integrated Circuit (ASIC), and respective modules perform some functions. However, such a module does not have a meaning limited to software or hardware. Such a module may be implemented to be present in an addressable storage medium or configured to execute one or more processors. The functions provided by components and modules may be combined into fewer components and modules, or may be further separated into additional components and modules.

Although the apparatus and method according to the present invention have been described in relation to specific embodiments, all or some of the components or operations thereof may be implemented using a computer system having general-purpose hardware architecture.

Furthermore, the embodiments of the present invention may also be implemented in the form of storage media including instructions that are executed by a computer, such as program modules executed by the computer. The computer-readable media may be arbitrary available media that can be accessed by the computer, and may include all of volatile and nonvolatile media and removable and non-removable media. Further, the computer-readable media may include all of computer storage media and communication media. The computer-storage media include all of volatile and nonvolatile media and removable and non-removable media, which are implemented using any method or technology for storing information, such as computer-readable instructions, data structures, program modules or additional data. The communication media typically include transmission media for computer-readable instructions, data structures, program modules or additional data for modulated data signals, such as carrier waves, or additional transmission mechanisms, and include arbitrary information delivery media.

The description of the present invention is intended for illustration, and those skilled in the art will appreciate that the present invention can be easily modified in other detailed forms without changing the technical spirit or essential features of the present invention. Therefore, the above-described embodiments should be understood as being exemplary rather than restrictive. For example, each component described as a single component may be distributed and practiced, and similarly, components described as being distributed may also be practiced in an integrated form.

The scope of the present invention should be defined by the accompanying claims rather than by the detailed description, and all changes or modifications derived from the meanings and scopes of the claims and equivalents thereof should be construed as being included in the scope of the present invention.

1. A video decoding apparatus, comprising:
an adaptive inverse quantization unit for performing inverse quantization on a block to be decoded using scaling list information, which is set for a certain region including the block to be decoded in an image, among pieces of scaling list information separately set for respective partitioned regions of the image.

2. The video decoding apparatus of claim 1, further comprising an entropy decoding unit for extracting pieces of predictive scaling list information and pieces of residual scaling list information, which are separately set for respective regions, from a bitstream,
wherein the predictive scaling list information is selected from scaling list information, which is set for a first region including a block in a reference image temporally coincident with the block to be decoded, and scaling list information, which is set for a second region including a neighboring block spatially adjacent to the block to be decoded, and
wherein the residual scaling list information is generated from a difference between the predictive scaling list information and the set scaling list information.

3. The video decoding apparatus of claim 1, wherein the regions are generated by partitioning the image by a unit corresponding to any one of a picture, a slice, a tile, and a quad-tree.

4. The video decoding apparatus of claim 1, wherein the pieces of scaling list information are separately set for respective regions based on results of analyzing visual perception characteristics of the image.

5. The video decoding apparatus of claim 4, wherein the visual perception characteristics include at least one of a luminance adaptation effect, a contrast sensitivity function effect, and a contrast masking effect.

6. The video decoding apparatus of claim 1, further comprising an entropy decoding unit for extracting flag information that indicates whether to perform merging for the scaling list information from a bitstream,
wherein whether to perform merging for the scaling list information is determined depending on a position of a predetermined region in the image.

7. The video decoding apparatus of claim 6, wherein, when the neighboring region spatially adjacent to the predetermined region is present on an upper or left side of the predetermined region, the entropy decoding unit extracts flag information indicating that merging for the scaling list information of the predetermined region is possible.

8. The video decoding apparatus of claim 1, wherein:
the adaptive inverse quantization unit performs inverse quantization using scaling values in the scaling list information set for the certain region, and
the scaling values are separately set for respective lower blocks depending on frequency characteristics of lower blocks constituting the block to be decoded.

9. The video decoding apparatus of claim 1, wherein:
the adaptive inverse quantization unit performs inverse quantization using scaling values in scaling list information set for the certain region,
the scaling values are separately set for respective lower block bands, each including two or more lower blocks, depending on frequency characteristics of lower blocks constituting the block to be decoded, and
a number of lower block bands is variably determined.

10. A video decoding method, comprising:
extracting pieces of scaling list information, which are separately set for respective partitioned regions of an image, from a bitstream; and
performing inverse quantization on a block to be decoded, using scaling list information set for a certain region including a block to be decoded in the image, among the pieces of scaling list information.

11. The video decoding method of claim 10, wherein:
the extracting comprises extracting pieces of predictive scaling list information and pieces of residual scaling list information, which are separately set for respective regions, from the bitstream, and generating a predicted signal corresponding to the block to be decoded, based on the predictive scaling list information and the residual scaling list information,
the predictive scaling list information is selected from scaling list information, which is set for a block in a reference image temporally coincident with the block to be decoded, and scaling list information, which is set for a neighboring block spatially adjacent to the block to be decoded, and
the residual scaling list information is generated from a difference between the predictive scaling list information and the set scaling list information.

12. The video decoding method of claim 10, wherein:
the extracting comprises extracting flag information that indicates whether to perform merging for the scaling list information,
whether the scaling list information set for the certain region has been merged with scaling list information set for another region is determined based on the flag information, and
whether to perform merging for the scaling list information is determined depending on a position of a predetermined region in the image.

13. The video decoding method of claim 10, wherein:
the performing the inverse quantization is configured to perform inverse quantization using scaling values in the scaling list information set for the certain region, and
the scaling values are separately set for respective lower blocks depending on frequency characteristics of lower blocks constituting the block to be decoded.

14. The video decoding method of claim 10, wherein:
the performing the inverse quantization is configured to perform inverse quantization using scaling values in scaling list information set for the certain region,
the scaling values are separately set for respective lower block bands, each including two or more lower blocks, depending on frequency characteristics of lower blocks constituting the block to be decoded, and
a number of lower block bands is variably determined.

15. A video decoding apparatus, comprising:
a region partitioning unit for, when a current block to be decoded is encoded in a partial block copy mode, among intra-prediction modes, partitioning a corresponding region, which corresponds to the current block, in a previously decoded area into an arbitrary shape; and
a predicted signal generation unit for generating respective predicted signals for the current block based on an intra-prediction mode or an intra-block copy mode for respective corresponding regions partitioned by the region partitioning unit.

16. The video decoding apparatus of claim 15, wherein the region partitioning unit partitions the corresponding region into two or more sub-regions using a curve or a straight line.

17. The video decoding apparatus of claim 15, wherein:
the region partitioning unit partitions the corresponding region based on a predetermined contour contained in the corresponding region, and
the predetermined contour is one of respective contours contained in a plurality of lower regions constituting the previously decoded area, and is determined based on results of analyzing similarities between the respective contours and a contour contained in the current block.

18. The video decoding method of claim 15, wherein:
the region partitioning unit partitions the corresponding region based on a distribution of predetermined pixel values in the corresponding region, and
the distribution of predetermined pixel values is one of distributions of pixel values in respective lower regions constituting the previously decoded area, and is determined based on results of analyzing similarities between the respective distributions of pixel values and a distribution of pixel values in the current block.

19. The video decoding method of claim 15, wherein the region partitioning unit searches for the corresponding region, based on a block vector which is information about relative positions of the current block and the corresponding region, and partitions a searched corresponding region.

20. The video decoding method of claim 15, wherein the predicted signal generation unit is configured to:
generate a predicted signal based on the intra-prediction mode for a region for which the previously decoded area is adjacent to at least one of left and upper sides of the region, among the partitioned corresponding regions, and
generate a predicted signal based on the intra-block copy mode for a region for which the previously decoded area is not adjacent to the left and upper sides of the region, among the partitioned corresponding regions.

21. The video decoding apparatus of claim 15, further comprising a prediction mode determination unit for determining, using flag information extracted from a bitstream, whether the current block has been encoded in the partial block copy mode.

22. The video decoding apparatus of claim 21, wherein the flag information is included either in a picture parameter set for a picture group or a picture that includes the current block, or in a slice header for a slice or a slice segment that includes the current block.

23. The video decoding apparatus of claim 21, wherein the prediction mode determination unit determines, using region flag information extracted from a bitstream, whether each of lower blocks contained in a plurality of target blocks, which are spatially adjacent to each other and constitute an arbitrary row or column, has been encoded in the partial block copy mode, for each row or column.

24. The video decoding apparatus of claim 21, wherein the prediction mode determination unit is configured to, when the current block is a unit block having a minimum size, determine using partial flag information extracted from the bitstream whether each of lower blocks contained in the unit block has been encoded in the partial block copy mode, for each lower block.

25. the vide decoding apparatus of claim 24, wherein the prediction mode determination unit determines whether each of the lower blocks has been encoded in the partial block copy mode according to a z-scan order.

26. A video decoding method, comprising:
determining whether a current block to be decoded has been encoded in a partial block copy mode, among intra-prediction modes;
when the current block has been encoded in the partial block copy mode, partitioning a corresponding region, which corresponds to the current block, in a previously decoded area into an arbitrary shape; and
generating predicted signals for the current block, based on an intra-prediction mode or an intra-block copy mode for respective corresponding regions partitioned at the partitioning.

27. The video decoding method of claim 26, wherein the determining is configured to determine, using flag information extracted from a bitstream, whether the current block has been encoded in the partial block copy mode.

28. The video decoding method of claim 27, wherein the determining is configured to determine, using region flag information extracted from a bitstream, whether each of lower blocks contained in a plurality of target blocks, which are spatially adjacent to each other and constitute an arbitrary row or column, has flag information thereof, for each row or column, and the flag information indicates whether the lower block has been encoded in the partial block copy mode.

29. The video decoding method of claim 27, wherein the determining is configured to, when the current block is a unit block having a minimum size, determine, using partial flag information extracted from the bitstream, whether each of lower blocks contained in the unit block has been encoded in the partial block copy mode, for each lower block.

30. The video decoding method of claim 26, wherein the partitioning is configured to partition the corresponding region into two or more sub-regions using a curve or a straight line.

31. The video decoding method of claim 26, wherein:
the region partitioning unit partitions the corresponding region based on a predetermined contour contained in the corresponding region, and
the predetermined contour is one of respective contours contained in a plurality of lower regions constituting the previously decoded area, and is determined based on results of analyzing similarities between the respective contours and a contour contained in the current block.

32. The video decoding method of claim 26, wherein:
the region partitioning unit partitions the corresponding region based on a distribution of predetermined pixel values in the corresponding region, and
the distribution of predetermined pixel values is one of distributions of pixel values in respective lower regions constituting the previously decoded area, and is determined based on results of analyzing similarities between the respective distributions of pixel values and a distribution of pixel values in the current block.

33. The video decoding method of claim 26, wherein the partitioning comprises searching for the corresponding region based on a block vector that is information about relative positions of the current block and the corresponding region, and a searched corresponding region is partitioned.

34. The video decoding method of claim 26, wherein the predicted signal generation unit is configured to:
generate a predicted signal based on an intra-prediction mode for a region for which the previously decoded area is adjacent to at least one of left and upper sides of the region, among the partitioned corresponding regions, and
generate a predicted signal based on the intra-block copy mode for a region for which the previously decoded area is not adjacent to the left and upper sides of the region, among the partitioned corresponding regions.
